(19) United States
(12) Patent Application Publication
(10) Pub. No.: US 2022/0034351 A1
(43) Pub. Date: Feb. 3, 2022

(54) SYSTEMS, DEVICES AND METHODS FOR SECURING NON-LOAD BEARING WALLS

(71) Applicant: SIMPSON STRONG-TIE COMPANY INC., Pleasanton, CA (US)

(72) Inventors: Gueary Andrew BRIGHAM, Nashville, TN (US); Jeremy Scott PARK, Gallatin, TN (US); Troy HALE, Goodlettsville, TN (US); Adam TILLINGHAST, Nashville, TN (US)

(73) Assignee: SIMPSON STRONG-TIE COMPANY INC., Pleasanton, CA (US)

(21) Appl. No.: 17/369,137

(22) Filed: Jul. 7, 2021

Related U.S. Application Data
(60) Provisional application No. 63/060,223, filed on Aug. 3, 2020.

(51) Int. Cl. F16B 25/00; E04B 2/82

(52) U.S. Cl. CPC F16B 25/0031; E04B 2/82

(57) ABSTRACT

Disclosed are systems, devices and methods used in construction to secure one component, such as a header, to another component, such as a joist, while controlling spacing. Fasteners are used with a removable sleeve member having longitudinal ribs to secure the fastening assembly and prevent movement. An installation guide is provided that facilitates both flush and offset installation.

### CROSS-REFERENCE

This application claims the benefit of U.S. Provisional Application No. 63/060,223, filed Aug. 3, 2020, entitled Systems, Devices and Methods for Securing Non-Load Bearing Walls, which application is incorporated herein in its entirety by reference.

### BACKGROUND

The disclosure relates to systems, devices and methods used in construction to secure one component, such as a header, to another component, such as a joist, while controlling spacing.

As is known to those of skill in the art, interior non-load bearing walls are typically framed below load bearing components with a space between the components. The gap enables the load bearing components to deflect under the pre-designed loads. Without the space, e.g., if the components are flush, components meant to be non-load bearing become load-bearing or quasi-load bearing which could result in loads being transferred to structural components not designed to support loads.

Additionally, construction of wood framed buildings has become generally standardized with the introduction of pre-fabricated roof trusses and I-joist roof and floor systems. These systems allow carpenters to assemble pre-manufactured structural components to the structure using hardware designed to address the deflection needed for optimal performance of each assembly.

Wall hanging hardware that accommodates deflection has been designed and installed in many different ways with mixed results in use. Installation results can be negatively impacted when, for example, the hardware is too tight. Overbuilding of blocking systems for fastening and fastening horizontally into the laminations can also negatively impact the installation results. Additionally, a “silent floor” may not be silent at all after installation causing creaking and squeaking as one walks on the floor and the floor flexes.

An exemplar fastener is the Deflector SP available at www.fastcap.com. The product is an integrated system with a fastener and an integrated sleeve. In use, the combination of a fastener with a sleeve helps to eliminate squeaking floors, failures in I-joists from unblocked non-bearing wall lines, stress cracks in drywall, door compression and adjustment, uneven floors and noise transfer. An exemplar offset is the Deflector Offset which can be used during the installation process with the Deflector SP.

What is needed are fastener assemblies suitable for securing one component to another where the sleeve is removable prior to installation but securely engages the fastener after installation. An easily convertible installation guide which facilitates flush and offset installation is also desirable. Additionally, what is also needed are fastener assemblies suitable for use in a variety of applications. Applications include connecting a first material to a second material where the materials connected are, for example, wood, cold-formed steel (“CFS”), and concrete.

### SUMMARY

Disclosed are fastener assemblies suitable for securing one component to another where the sleeve is removable from the fastener. Also disclosed are fastener assemblies suitable for use in a variety of applications connecting a first material to a second material, where the materials can be selected from, for example, wood, CFS, and concrete. More specifically, for wood-to-wood, CFS-to-wood, and wood-to-concrete connections. Also disclosed is an installation guide which facilitates flush and offset installation.

An aspect of the disclosure is directed to fastener sleeves comprising a sleeve length from a proximal end to a distal end wherein the fastener sleeve defines a bore for removably receiving a fastener and further wherein the fastener sleeve can have one or more tapered longitudinal ribs on an exterior surface and the one or more tapered longitudinal ribs terminate prior to the distal end of the fastener sleeve. Embodiments of the fastener sleeve can have at least one of a tapered interior diameter and a tapered exterior diameter. Additionally, the fastener sleeve can have one or more distal slits. In some configurations, the one or more distal slits can have a slit length less than the fastener sleeve length. The distal end of the fastener sleeve can be operable to flex radially outward from a central axis. Additionally, the fastener sleeve can have a proximal flange. In some configurations, the proximal flange of the fastener sleeve can have a recess on a proximal surface operable to receive a fastener head. A proximal sleeve body recess can also be provided between a proximal end of the one or more ribs and a lower surface of the proximal flange.

Another aspect of the disclosure is directed to fastener sleeves comprising a sleeve length from a proximal end to a distal end wherein the fastener sleeve defines a bore for removably receiving a fastener and further wherein the fastener sleeve can have an integrally formed proximal flange and one or more distal slits. Embodiments of the fastener sleeve can have at least one of a tapered interior diameter and a tapered exterior diameter. Additionally, the fastener sleeve can have one or more distal slits. In some configurations, the one or more distal slits can have a slit length less than the fastener sleeve length. The distal end of the fastener sleeve can be operable to flex radially outward from a central axis. Additionally, the fastener sleeve can have a proximal flange. In some configurations, the proximal flange of the fastener sleeve can have a recess on a proximal surface operable to receive a fastener head. A proximal sleeve body recess can also be provided between a proximal end of the one or more ribs and a lower surface of the proximal flange. The fastener sleeves can have at least one of a tapered interior diameter and a tapered exterior diameter. Additionally, the fastener sleeves can further comprise one or more longitudinal ribs having a tapered depth along a length of the one or more longitudinal ribs. The one or more distal slits can have a slit length less than the fastener sleeve length. In at least some configurations, the distal end of the fastener sleeves can be operable to flex radially outward from a central axis. The proximal flange can also have a recess on a proximal surface operable to receive a fastener head. A proximal sleeve body recess can also be provided between a proximal end of the one or more ribs and a lower surface of the proximal flange.

Still another aspect of the disclosure is directed to fastener assemblies. Suitable fastener assemblies comprise: a fastener; and a fastener sleeve with a sleeve length from a proximal end to a distal end wherein the fastener sleeve defines a bore for removably receiving a fastener and further wherein the fastener sleeve can have one or more tapered longitudinal ribs on an exterior surface and the one or more tapered longitudinal ribs terminate prior to the distal end of the fastener sleeve. The fastener sleeve of the fastener assembly can have at least one of a tapered interior diameter and a tapered exterior diameter. Additionally, the fastener sleeve of the fastener assembly can have one or more distal slits. The one or more distal slits of the fastener sleeve can have a slit length less than the fastener sleeve length. The distal end of the fastener sleeve can also be operable to flex radially outward from a central axis. The fastener sleeve can have a proximal flange, and the proximal flange of the fastener sleeve can also have a recess on a proximal surface operable to receive a fastener head. The fastener sleeve can further comprise a proximal sleeve body recess between a proximal end of the one or more ribs and a lower surface of the proximal flange.

Yet another aspect of the disclosure is directed to fastener assemblies comprising: a fastener; and a fastener sleeve with a sleeve length from a proximal end to a distal end wherein the fastener sleeve defines a bore for removably receiving a fastener and further wherein the fastener sleeve can have an integrally formed proximal flange and one or more distal slits. The fastener sleeve of the fastener assembly can have at least one of a tapered interior diameter and a tapered exterior diameter. In some configurations, the fastener sleeve further comprises one or more longitudinal ribs having a tapered depth along a length of the one or more longitudinal ribs. Additionally, the one or more distal slits can have a slit length less than the fastener sleeve length. The distal end of the fastener sleeve can also be operable to flex radially outward from a central axis. The proximal flange can also have a recess on a proximal surface operable to receive a fastener head. In some configurations, the fastener sleeve further comprises a proximal sleeve body recess between a proximal end of the one or more ribs and a lower surface of the proximal flange.

Another aspect of the disclosure is directed to installation methods. Installation methods can include the steps of: providing a fastener assembly comprising a fastener having a fastener head and a threaded shaft, and a removable fastener sleeve; extending the fastener sleeve member of the fastener assembly through a hole in a target surface; and driving the threaded shaft of the fastener into the target surface while also setting a spacing gap, whereby the threaded fastener can be anchored in the target surface, and the spacing gap accommodates a deflection of the target surface. A flange at a proximal end of the fastener sleeve can be larger in diameter than a hole in a target surface. The methods can also include the step of providing an installation guide with a bit for engaging and rotating the fastener head, wherein the installation guide can have an axially aligned receptacle dimensioned to releasably retain the fastener assembly to provide a known depth to achieve at least one of a flush installation of the fastener assembly and an offset installation of the fastener assembly. The fastener assembly can be installed through a hole from below, and the fastener is threaded into a floor joist or a roof truss. The fastener can also have a length greater than a length of the fastener sleeve. In some methods, the fastener can translate within the fastener sleeve member to accommodate a vertical deflection. Additionally, the fastener sleeve can translate within a hole to accommodate deflection without loading a wall section. The methods can also include the step of providing a mounting clip for a ceiling panel installed adjacent to a wall section, wherein the mounting clip can be secured to an edge portion of the ceiling panel and spaced about a perimeter of the ceiling panel. Another method of the embodiment can include the step of securing the mounting clip to a top header of the wall section wherein the mounting clip can be being free of attachment to a floor joists or a roof truss. The methods may also include the step of forming a hole through a target surface.

Still another aspect of the disclosure is directed to a system comprising: a fastener; a fastener sleeve having a sleeve length from a proximal end to a distal end wherein the fastener sleeve defines a bore for removably receiving the fastener and further wherein the fastener sleeve can have one or more longitudinal ribs on an exterior surface; a bit having an e-clip; and an installation guide operable to securely receive a bit through a central aperture wherein the installation guide can have a first configuration for an offset installation and a second configuration for a flush installation. The fastener sleeve can have at least one of a tapered interior diameter and a tapered exterior diameter. In some configurations, the one or more longitudinal ribs of the fastener sleeve have a tapered depth along a length of the one or more longitudinal ribs. Additionally, the one or more longitudinal ribs may terminate prior to the distal end of the fastener sleeve. The fastener sleeve can also have one or more distal slits. The one or more distal slits can also have a slit length less than the fastener sleeve length. The distal end of the fastener sleeve can also be operable to flex radially outward from a central axis. In some configurations, the fastener sleeve can have a proximal flange. The proximal flange can also have a recess on a proximal surface operable to receive a fastener head. A proximal sleeve body recess can also be provided between a proximal end of the one or more ribs and a lower surface of the proximal flange. Additionally, the installation guide can have a plurality of external ribs and a distal cavity.

Another aspect of the disclosure is directed to kits comprising: a fastener; a fastener sleeve having a sleeve length from a proximal end to a distal end wherein the fastener sleeve defines a bore for removably receiving the fastener further wherein the sleeve can have one or more tapered longitudinal ribs on an exterior surface and the one or more tapered longitudinal ribs terminate prior to the distal end of the sleeve; a bit having an e-clip; and an installation guide operable to securely receive a bit through a central aperture wherein the installation guide can have a first configuration for an offset installation and a second configuration for a flush installation.

Still another aspect of the disclosure is directed to kits comprising: a fastener; a fastener sleeve with a sleeve length from a proximal end to a distal end wherein the fastener sleeve defines a bore for removably receiving a fastener and further wherein the fastener sleeve can have an integrally formed proximal flange and one or more distal slits; a bit having an e-clip; and an installation guide operable to securely receive a bit through a central aperture wherein the installation guide can have a first configuration for an offset installation and a second configuration for a flush installation.

Another aspect of the disclosure is directed to a method for installing a wall section having a vertical wall stud and a top header extending along the top end of the wall section, in a frame structure having a plurality of floor joists or roof trusses extending above the wall section, the method includes the steps of: providing a plurality of fastener assemblies, each fastener assembly having a threaded fastener extending through a fastener sleeve, the fastener sleeve having at least one of one or more external ribs and one or more distal slits; forming a plurality of holes extending vertically through the top header of the wall section, each hole being generally aligned with one of the floor joists or roof trusses; extending the sleeve member of one of the fastener assemblies vertically and slidably through one of the holes and through the top header of the wall section; and driving the respective threaded fastener through the sleeve member into the aligned floor joist or roof truss to achieve a spacing gap between the floor joist or roof truss and the top header of the wall section, whereby the threaded fastener is anchored in the floor joist or roof truss and the wall section is supported, and the spacing gap accommodates vertical deflection of the frame structure without impinging on and loading the wall section.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

DE 8715882 U1 published Feb. 25, 1988 by Schuffenhauer;

EP 1972799 A1 published Sep. 24, 2008 by Huang;

ES 1050526 published Aug. 1, 2002 by Kao;

GB 1498838 published Jan. 25, 1978 by Huck;

GB 2109433A published Jun. 2, 1983 by Slater;

GB 2385398A published Aug. 20, 2003 by Klippel;

U.S. Pat. No. 1,683,796A published Sep. 11, 1928 by Pearce;

U.S. Pat. No. 2,940,488A published Jun. 14, 1960 by Riley Jr.;

U.S. Pat. No. 3,260,544A published Jul. 12, 1966 by Hathaway Jr.;

U.S. Pat. No. 3,881,293A published May 6, 1975 by Conville;

U.S. Pat. No. 4,370,082A published Jan. 25, 1983 by Sundberg;

U.S. Pat. No. 4,416,572A published Nov. 22, 1983 by Black;

U.S. Pat. No. 4,801,230A published Jan. 31, 1989 by Wilburn;

U.S. Pat. No. 5,906,080A published May 25, 1999 by diGirolamo et al.;

U.S. Pat. No. 6,868,757B2 published Mar. 22, 2005 by Hufnagl et al.;

U.S. Pat. No. 6,942,439B2 published Sep. 13, 2005 by Rouger;

U.S. Pat. No. 7,387,054B2 published Jun. 17, 2008 by Rajotte;

U.S. Pat. No. 8,458,972B1 published Jun. 11, 2013 by Stodola et al.;

U.S. Pat. No. 9,360,032B2 published Jun. 7, 2016 by Dicaire;

U.S. Pat. No. D379,578S published Jun. 3, 1997 by Daniels;

U.S. Pat. No. 10,145,404B2 published Dec. 4, 2018 by Shadwell;

U.S. Pat. No. 10,150,206B2 published Dec. 11, 2018 by Ko;

U.S. Pat. No. 10,590,978B2 published Mar. 17, 2020 by Shadwell;

US 2006/0067803A1 published Mar. 30, 2006 by Hsu;

US 2007/0122253A1 published May 31, 2007 by Murtha;

US 2007/0258787A1 published Nov. 8, 2007 by Hsu;

US 2014/0360123A1 published Dec. 11, 2014 by Dicaire;

US 2016/0279769A1 published Sep. 29, 2016 by Arslan;

US 2017/0218996A1 published Aug. 3, 2017 by Takeda et al.;

US 2019/0127974A1 published May 2, 2019 by Dicaire et al.;

WO 2016/205119A1 published Dec. 22, 2016 by Kennelly;

FASTCAP DEFLECTOR FASTENER product information (accessed May/2020); and

FASTCAP DEFLECTOR OFFSET TOOL product information (accessed May/2020).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-H illustrates the system including a fastener, a sleeve, an installation guide, and a bit; FIG. 1A is a side view, FIG. 1B is a first perspective view;

FIG. 1C is a second perspective view; FIG. 1D is a view from the distal end; FIG. 1E is a view from the proximal end; FIG. 1F is a cross-sectional view along a first axis with the installation guide in an offset position; FIG. 1G is a cross-sectional view along a second axis, perpendicular to the first action at approximately G-G shown in FIG. 1F;

FIG. 1H illustrates a cross-section with the installation guide in a flush position;

FIGS. 2A-G illustrate a sleeve; FIG. 2A is a side-view of the sleeve; FIG. 2B is a first perspective view of the sleeve; FIG. 2C is a second perspective view of the sleeve; FIG. 2D is a view of the sleeve from the distal end; FIG. 2E is a view of the sleeve from the proximal end; FIG. 2F is a cross-sectional view along the lines F-F in FIG. 2A; FIG. 2G is a cross-sectional view along the lines G-G in FIG. 2A;

FIGS. 3A-B is a side view and a cross-sectional view of a sleeve similar to the sleeve show in FIGS. 2A-G except that a recess is provided;

FIGS. 4A-B illustrates the sleeve of FIG. 2 with a fastener; FIG. 4A is a side view of the sleeve with the fastener; FIG. 4B is a cross-sectional view of the sleeve with the fastener;

FIGS. 5A-B illustrates the sleeve from FIG. 3 with a fastener; FIG. 5A is a side view of the sleeve with the fastener; FIG. 5B is a cross-sectional view of the sleeve with the fastener;

FIG. 6 illustrates use of the system to install a fastener and a sleeve to connect a first wood element to a second wood element in flush installation; and

FIG. 7 illustrates use of the system to install a fastener and a sleeve to connect a first wood element to a second wood element in an offset installation; and

FIGS. 8A-C illustrate various installations of a fastener and a sleeve.

### DETAILED DESCRIPTION

### I. Systems

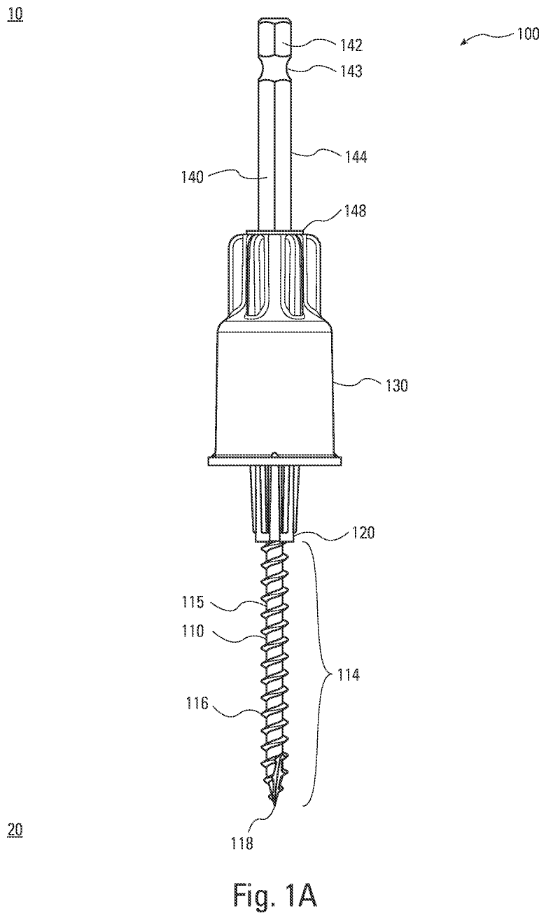

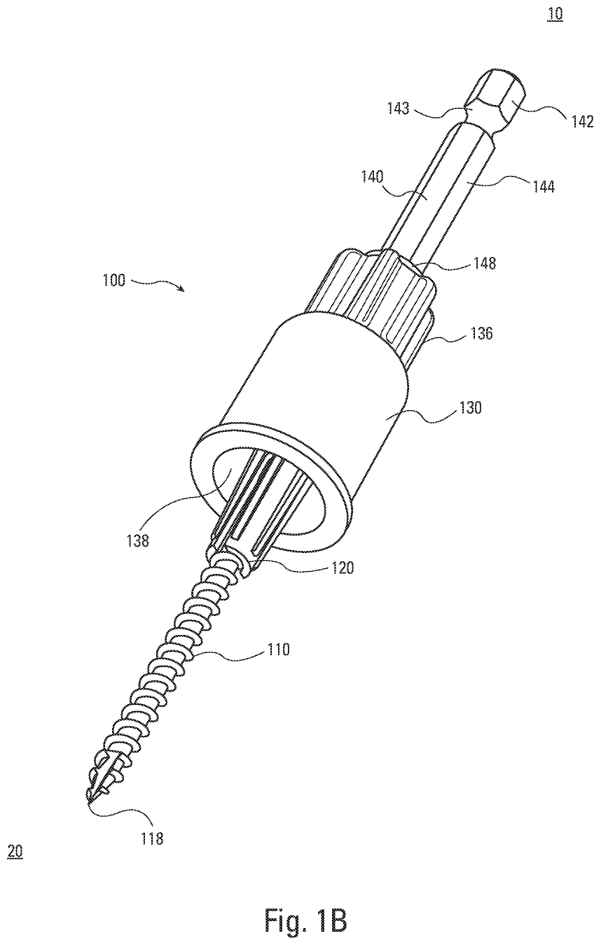

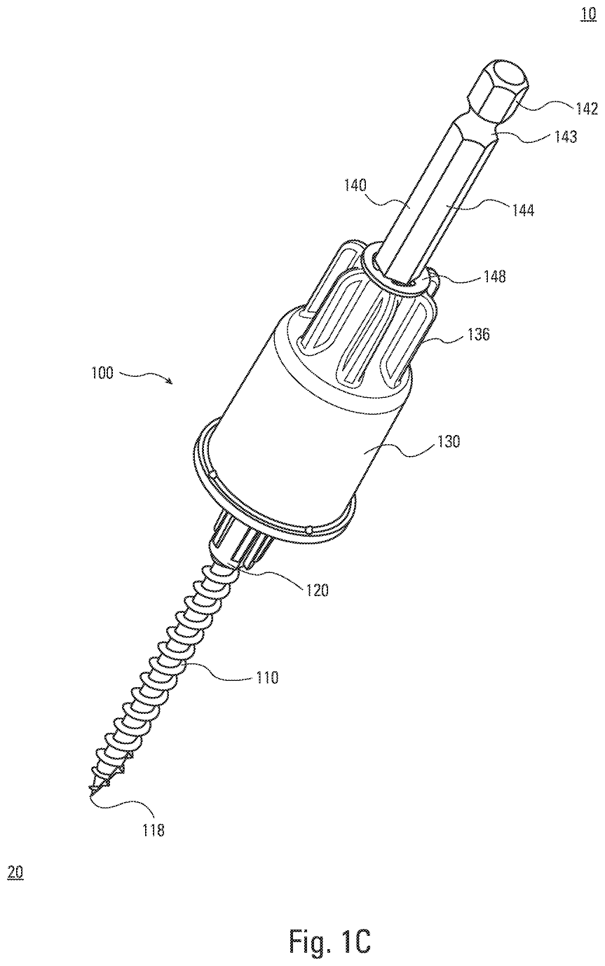

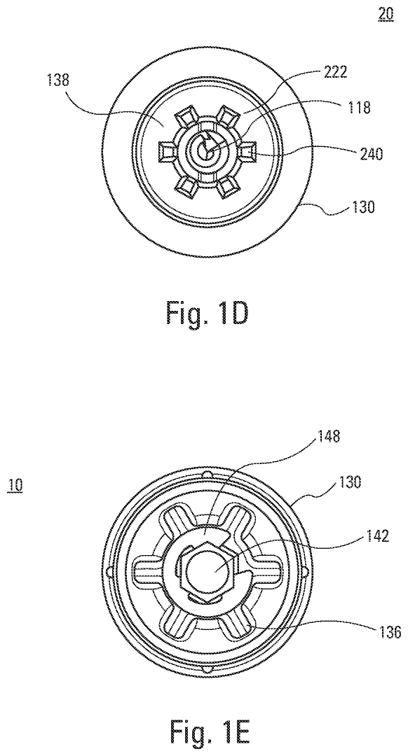

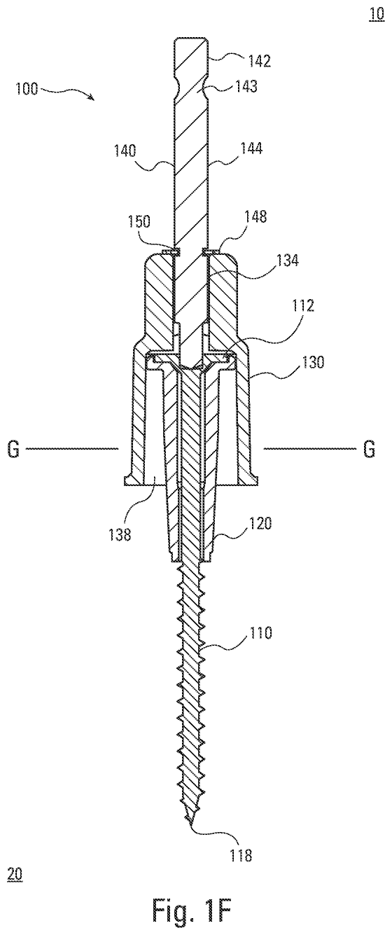

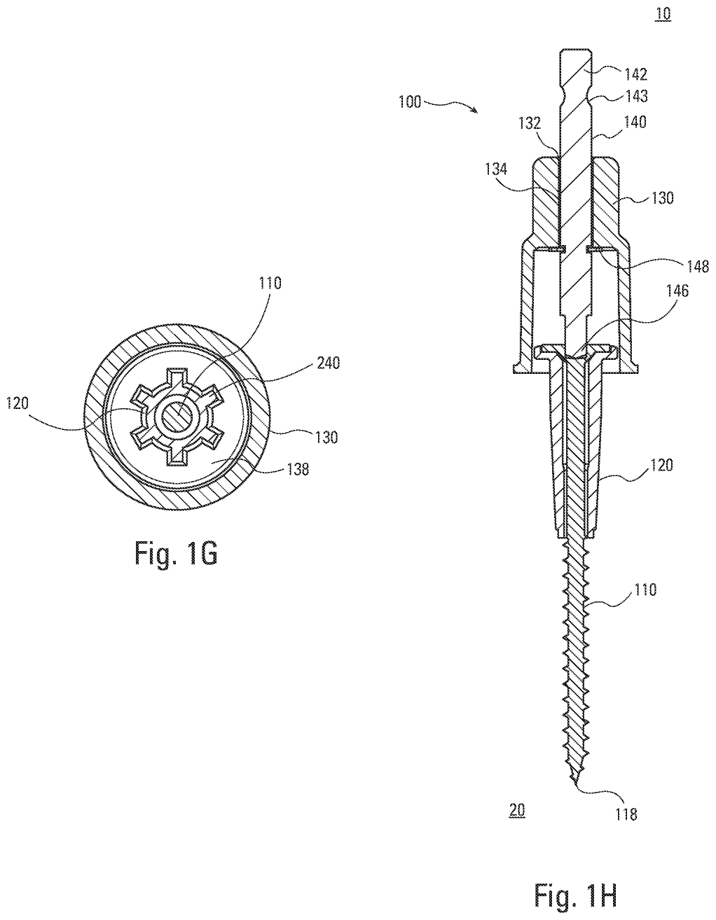

FIGS. 1A-H illustrates a fastener installation system 100 including a fastener 110 (such as a tapping screw), a sleeve 120, an installation guide 130, and a bit 140. The combination of the fastener 110 and the sleeve 120 form a fastener assembly. The fastener installation system can be used with a suitable driver, such as a heavy-duty hand tool. Suitable heavy duty tools include, for example, power drills. A length extending adaptor can also be used as part of the system. The length-extending adaptor can be a fixed length-extending adaptor or a telescoping length-extending adapter. The total length can vary depending on the application. A suitable length-extending adapter can be, for example, an 18″ Deflector Extension that allows for installation of fastener assemblies from floor level.

Turning to FIG. 1A, a side view of the fastener installation system 100 is illustrated. The distal end 20 of the fastener 110 tapers into a point 118. A threaded shaft 114 of the fastener 110 is shown extending from the distal end 20 of the sleeve 120. The threaded shaft 114 of the fastener 110 has threads 116 that extend from a fastener surface 115. As is known in the art, a major diameter for the fastener 110 is measured from the crest or top of the thread 116 on opposing sides of the fastener 110 at a proximal position near the shank (where the diameter is the greatest), and a minor diameter is measured from the thread valley or bottom of the thread 116 on opposing sides of the fastener 110 at a distal position near the point 118 or tip (where the diameter is the smallest). The head of the fastener 110 and the unthreaded shaft or shank are positioned below the installation guide 130. As will be appreciated by those skilled in the art, the length of the fastener 110 can vary depending on the installation needs and the shape of the fastener bit interface 111 can vary depending on the type of bit 140 used without departing from the scope of the disclosure. Additionally, the major diameter of the fastener 110, the minor diameter of the fastener 110, the length of an unthreaded shaft 113, and the threaded shaft 114, can also change depending on the installation needs without departing from the scope of the disclosure.

FIG. 1B is a first perspective view from a distal 20 orientation and FIG. 1C is a second perspective view from a proximal 10 orientation, where the distal end 20 is farthest from the user and the proximal end 10 is closest to the user. The installation guide 130 has a guide aperture 132 (shown in FIG. 1H), a channel 134 (shown in FIG. 1F), a plurality of external guide member ribs 136 and a cavity 138 for receiving the sleeve 120 and the fastener 110. The installation guide 130 can have a length from a proximal end 10 to a distal end 20 of about 1.74 cm. The length of the guide aperture 132 can be about 0.725 cm. The interior depth of the installation guide cavity 138 can be about 1.02 cm. The wall thickness of the installation guide cavity 138 can be about 0.10 cm. The width of the installation guide aperture 132 is sized and shaped to securely engage the bit 140 and can have a width of about 0.25 cm. Additionally, the shape of the installation guide aperture 132 can be hexagonal to match the exterior shape of the bit 140. Other shapes can be used without departing from the scope of the disclosure.

A proximal end 10 of the bit 140 is shown with the hex shank 142, a ball groove 143 or neck and a bit body 144. The hex shank 142 of the bit 140 is operable to engage a chuck of, for example, a power screwdriver during use. An e-clip 148 is provided which fits within a recess on the surface of the bit body 144. The e-clip 148 allows the bit to engage the installation guide 130 in a first orientation for flush installation and a second orientation for recessed installation by changing how the bit 140 engages the installation guide 130, as discussed below. The bit 140 can have an overall length from a proximal end 10 to a distal end 20 of 2.50 cm. An e-clip groove 150 is provided along the length of the bit 140 to securely receive the e-clip 148. The e-clip groove 150 is positioned 1.60 cm from the proximal end 10 of the bit 140.

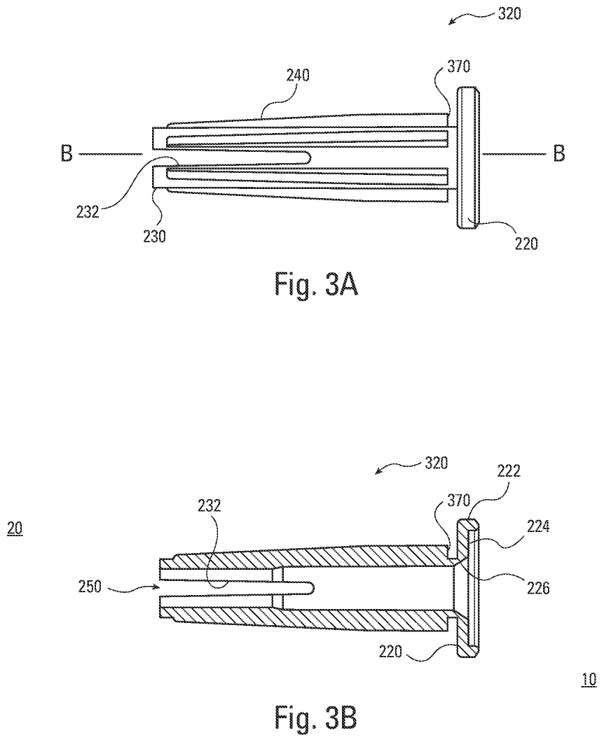

FIG. 1D is an end view of the fastener installation system 100 from the distal end 20 with the flange 220, or shoulder, of a sleeve 120 positioned within a cavity 138 of the installation guide 130, and the tip 118 of the fastener 110 having a smaller diameter than the sleeve body 230. Ribs 240 of the sleeve 120 are shown. As will be appreciated by those skilled in the art, the sleeve 320 of FIG. 3 would have a similar appearance.

FIG. 1E an end view of the fastener installation system 100 from the proximal end 10. From this view, the proximal end of the hex shank 142 of the bit is shown along with the e-clip 148. The e-clip 148 is positioned against the installation guide 130 with the external guide member ribs 136 visible.

FIG. 1F is a cross-sectional view along a first longitudinal axis with the installation guide 130 in an offset installation configuration. The offset installation configuration is achieved when the e-clip 148, securely nested within the e-clip groove 150 of the bit 140, is positioned adjacent the surface at the proximal end 10 of the installation guide 130 when the bit 140 is located within the channel 134 of the installation guide 130. The fastener 110 and sleeve 120 are positioned within a recess 138 of the installation guide 130.

FIG. 1G is a cross-sectional view along a second axis, perpendicular to the first longitudinal axis, at G-G in FIG. 1F. A cross-section of the fastener 110 is shown within a central opening of the sleeve. A plurality of ribs 240 (illustrated as six ribs) is positioned within a guide channel 134. FIG. 111 illustrates a cross-section along the first longitudinal axis with the installation guide 130 in a flush configuration with the secured e-clip 148 positioned within an interior cavity of the installation guide 130.

The bit 140 can removably engage the installation guide 130, so that the installation guide 130 can quickly and easily toggle between an offset drive installation position (as shown in FIG. 1F) and a flush drive installation position (as shown in FIG. 111) by changing the relative position of the secured e-clip 148 to the installation guide 130. As will be appreciated by those skilled in the art, the position of the e-clip 148 does not change. Thus, for the offset drive position shown in FIG. 1F, the distal end 20 of the bit 140 is inserted into the proximal end 10 of the channel 134 of the installation guide 130. For the flush drive position shown in FIG. 111, the proximal end 10 of the bit 140 is inserted into distal end 20 of the channel 134 of the installation guide 130 through the cavity 138.

### II. Sleeves and Fasteners

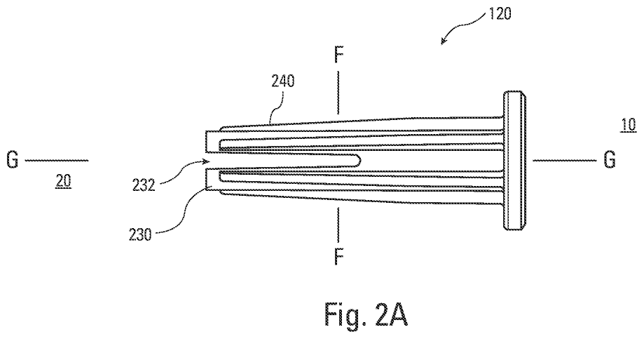

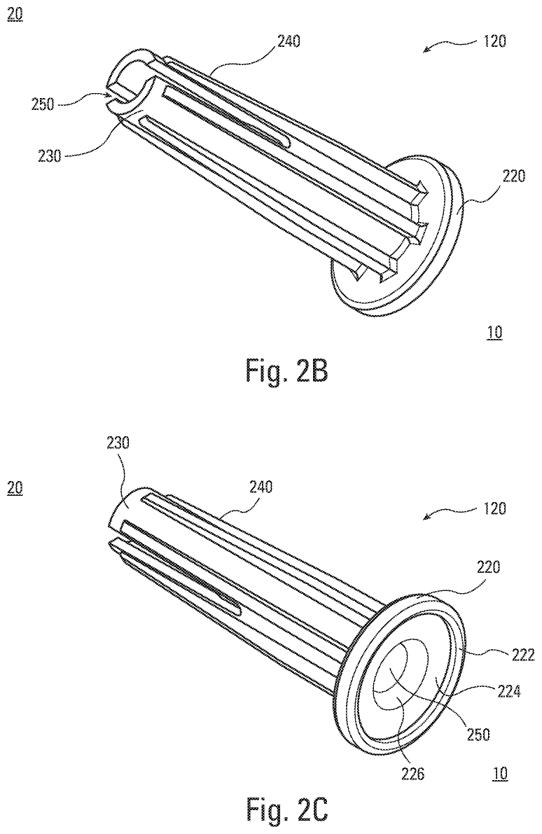

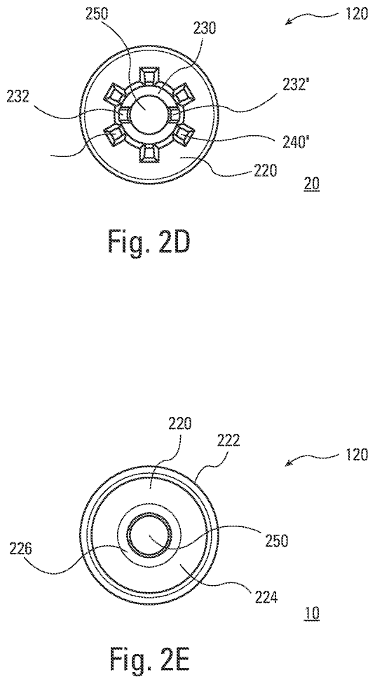

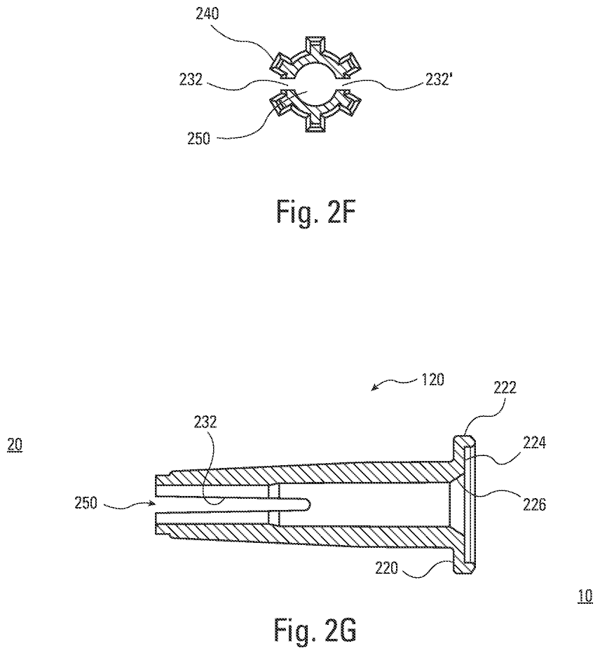

FIGS. 2A-G illustrate a sleeve 120 for use in, for example, a wood application. FIG. 2A is a side-view of the sleeve 120. The sleeve 120 has a flange 222 or shoulder at a proximal end 10 connected to a sleeve body 230. The flange 222 can be integrally formed with the body of the sleeve 120. The sleeve 120 is configurable to taper in either or both of its internal diameter (i.e. the diameter of the bore 250) and its external diameter (i.e., diameter of the sleeve body 230) from the proximal end 10 to its distal end 20. The internal diameter of the bore 250 at the proximal end 10 is the same or greater than the major diameter of the fastener 110. The internal diameter of the bore 250 at the distal end 20 is the same or less than the major diameter of the fastener 110. Where the internal diameter of the bore 250 is less than the major diameter of the fastener 110, the longitudinal slit 232 or slot enables the distal end 20 of the sleeve body 230 to radially flex away from a central longitudinal axis of the sleeve 120 to temporarily facilitate a greater distal diameter of the sleeve 120 or towards a central longitudinal axis to reduce the distal diameter of the sleeve, thus allowing the sleeve 120 to flexibly and removably engage the fastener 110. The sleeve 120 can be rigid along the length of the sleeve body 230, flexible along the sleeve body 230 or have a rigid proximal section and a flexible distal section.

One or more longitudinal slits 232 are provided which extend from a distal end 20 partway along the length of the sleeve body 230. The length of the longitudinal slits 232 can, for example, be from 25% to 75% of the overall length of the sleeve 110. Where there is more than one longitudinal slit 232, the length of each longitudinal slit 232 can be the same.

One or more ribs 240 can be provided on at least a portion of the outside surface of the sleeve body 230. The one or more ribs 240 can extend from a distal surface 20 of the proximally positioned flange 220 along the length of the sleeve body 230. As illustrated, the one or more ribs 240 can terminate prior to the distal end 20 of the sleeve body 230. In other configurations, the one or more ribs 240 can terminate, for example, at or near the proximal end of the longitudinal slit 232 or at the distal end 20 of the sleeve body 230. The one or more ribs 240 can also be operable to have a rib height that tapers along its length with, for example, a greater rib height at a proximal end 10 and a lower rib height at a distal end 20. In use, the one or more ribs 240 discourage sleeve movement as discussed below.

FIG. 2B is a first perspective view of the sleeve 120 taken from a distal end 20. As evident from this view, the sleeve body 230 tapers in external diameter from the proximal end 10 to the distal end 20 and the one or more ribs 240 can be operable to terminate prior to the distal most end of the sleeve body 230. The sleeve 120 defines a continuous aperture 250 throughout the center of the sleeve 120. The continuous aperture 250 is sized to receive a fastener 110 therethrough.

FIG. 2C is a second perspective view of the sleeve 120 from a proximal end 10. As will be appreciated from this view, the flange 220 or shoulder can have a lip 222, which sets an inner diameter of an upper sleeve recess 224. The sleeve recess 224 is configurable to receive and nest the fastener head from a fastener sized to be paired with the sleeve 120. An aperture 250 receives the shaft of the fastener into the sleeve 120. The flange 220 can have a tapered or beveled surface 226 leading to the aperture 250 or bore if the fastener head has a corresponding tapered portion or neck leading to the fastener shank. In some configurations, the flange 220 does not provide a tapered or beveled surface in order for the fastener to be flush or recessed with the upper interface of the flange. Instead, the flange 220 can have a flat surface and aperture such that the head of the fastener is positioned against the upper surface of the flange.

FIG. 2D is a view of the sleeve 120 from the distal end 20. The flange 220 has a diameter that is larger than the diameter of the sleeve body 230. Two slits 232, 232′ are provided on either side of the sleeve body 230. As will be appreciated by those of skill in the art, a configuration with one or more slits can be provided without departing from the scope of the disclosure. Additionally, the slits can be equally spaced apart around the diameter of the sleeve body 230. The sleeve body 230 is also illustrated with a plurality of ribs 240, 240′. FIG. 2E is a view of the sleeve 120 from the proximal end 10. From the proximal end 10, the flange 220 is illustrated showing a continuous lip 222 around the exterior of the flange 220. As will be appreciated by those skilled in the art, the lip 222 need not be continuous and may be comprised of one or more sections. The height of the lip 222 can correspond to the height of the fastener head 112 so that the combination of the fastener 110 and the lip 222 of the sleeve 120 present a uniform, or substantially uniform flat surface at the proximal interface of the fastener assembly.

In some configurations, it may be desirable for the lip 222 to have a height that is greater than the height of the fastener head 112, so that the fastener head 112 is recessed within the flange 220. In other configurations, as noted above, the flange may have a flat surface, which is positioned below the fastener head. The diameter of the flange can be the same or less than the diameter of the fastener head.

FIG. 2F is a cross-sectional view along the lines F-F in FIG. 2A. The cross-section illustrates the aperture 250 created by the sleeve 120 through which the fastener passes, and the exterior ribs 240 on the outside surface of the sleeve body 230. Gaps are also present in the cross-section at the location where the longitudinal slits 232, 232′ are present in a configuration with two longitudinal slits positioned on opposite sides of the sleeve body. As will be appreciated by those skilled in the art, the position of the gap or gaps would change where the number and/or location of slits changed.

FIG. 2G is a cross-sectional view along the lines G-G in FIG. 2A of the sleeve 120. The sleeve body 230 is shown tapering slightly from a proximal end 10 to a distal end 20. The sleeve 120 defines an aperture 250 through which a fastener can pass. A longitudinal slit 232 is shown which starts at the distal end 20 and ends approximately midway along the length of the sleeve body 230. The flange 220 has a lip 222 with an upper sleeve recess 224 and a taper 226.

FIGS. 3A-B illustrate a sleeve 320 similar to the sleeve in FIGS. 2A-G. The sleeve 320 differs in this configuration by providing a proximal sleeve body recess 370 between the ribs 240 and the flange 222. This configuration of a sleeve 320 is particularly suitable for use in construction applications that include securing a cold form steel panel. FIG. 3A is a side exterior view of the sleeve 320. FIG. 3B is a cross-sectional view along the length of the sleeve 320 similar to the view in FIG. 2G.

Additional exemplar dimensions for the sleeve include:

TABLE 1
EXEMPLAR SLEEVE DIMENSIONS

| Element | Dimension (inches) |
|---|---|
| Sleeve (120, 320) | |
| Length | 1.25-8.00 |
| Sleeve body (230) | |
| Width (external surface)-Proximal end (10) | 0.30-0.50 |
| Width (external surface)-Distal end (20) | 0.30-0.38 |
| Aperture diameter (interior)-Proximal end (10) | 0.20-0.30 |
| Aperture diameter (interior)-Distal end (20) | 0.18-0.28 |
| Flange (220) | |
| Thickness | 0.05-0.12 |
| Width | 0.6-2.0 |
| Lip (222) height (exterior) | 0.06-0.12 |
| Recess (224) depth (interior) | 0.02-0.6 |
| Rib (240) | |
| Length | 0.4-7.2 |
| Length (as percentage of overall sleeve body | 30%-90% |
| length) | |
| Width-Proximal end (10) | 0.04-0.08 |
| Width-Distal end (20) | 0.03-0.07 |
| Height/Thickness-Proximal end (10) | 0.04-0.10 |
| Height/Thickness-Distal end (20) | 0.04-0.08 |
| Longitudinal Distal Slit (232) | |
| Length | 0.50-2.00 |
| Width-Proximal end (10) | 0.04-0.06 |
| Width-Distal end (20) | 0.07-0.09 |

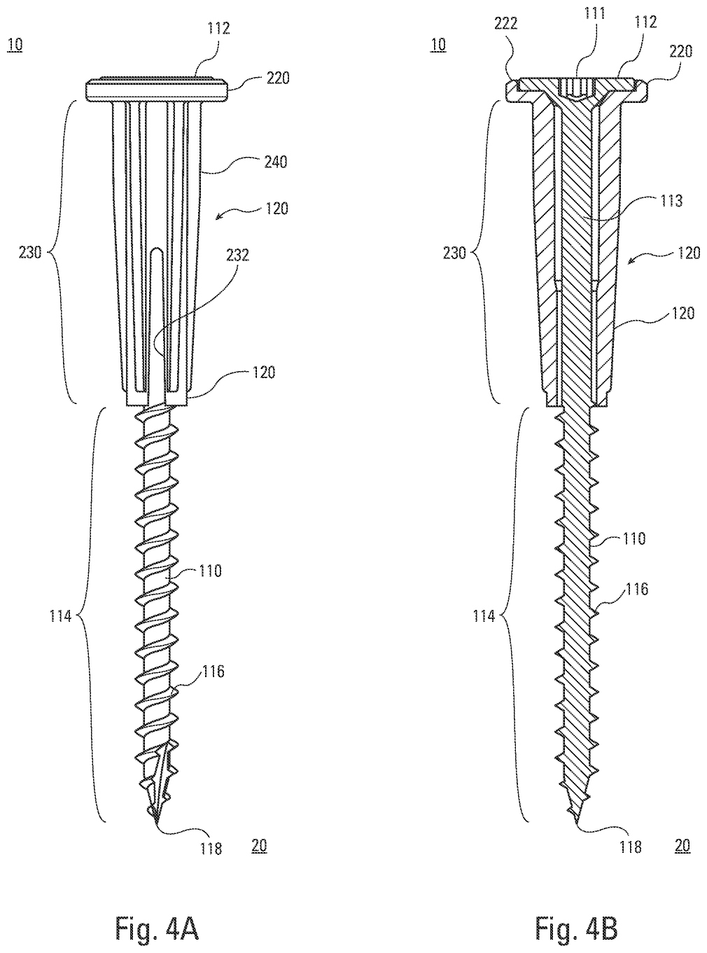

FIGS. 4A-B illustrates a fastener assembly that includes the sleeve 120 of FIG. 2 with a fastener 110. FIG. 4A is a side exterior view of the sleeve 120 with the fastener 110. The sleeve 120 has a flange 220 and a sleeve body 230. Along at least a portion of the length of the sleeve body 230 on its exterior surface are one or more ribs 240. The ribs 240 can connect on a proximal end 10 to the flange 220 and terminate prior to the distal end 20 of the sleeve body 230. One or more longitudinal slits 232 can be provided in the sleeve body 230. The longitudinal slit 232 has an opening at the distal end 20 of the sleeve and terminates prior to the flange 220. The slit 232 is used to facilitate removability of the sleeve 120 with respect to the fastener 110 by allowing the opening at the distal end 20 to radially flex outward. FIG. 4B is a cross-sectional view of the sleeve 120 taken longitudinally with the fastener 110. The flange 220 of the sleeve 120 can be provided with a lip 222 that has a height sufficient to receive the fastener head 112. A tapered upper sleeve recess 224 can be provided which accommodates a tapered portion between the fastener head 112 and the shank 113.

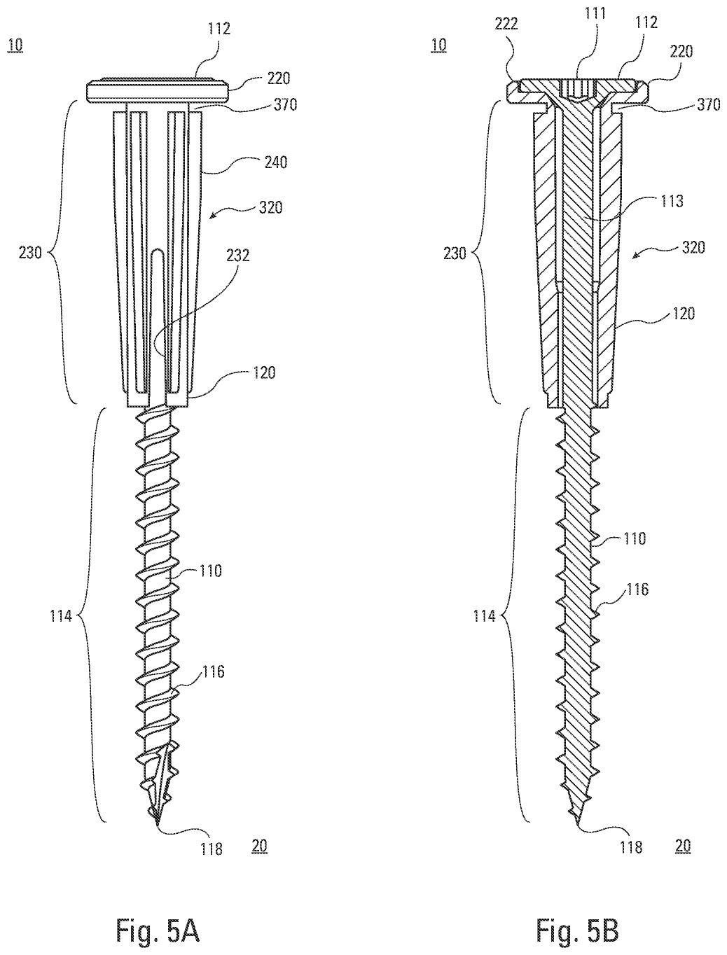

FIG. 5A is a side exterior view of a fastener assembly including the sleeve 320 with the fastener 110. The sleeve 320 has a flange 220 and a sleeve body 230. Along at least a portion of the length of the sleeve body 230 on its exterior surface are one or more ribs 240. The ribs 240 can connect on a proximal end 10 to the flange 220 and terminate prior to the distal end 20 of the sleeve body 230. One or more longitudinal slits 232 can be provided in the sleeve body 230. The longitudinal slit 232 has an opening at the distal end 20 of the sleeve and terminates prior to the flange 220. The slit 232 is used to facilitate removability of the sleeve 320 with respect to the fastener 110 by allowing the opening at the distal end 20 to radially flex outward. Additionally, a sleeve body recess 370 is provided between the ribs 240 and the flange 220. FIG. 5B is a cross-sectional view of the sleeve 320 taken longitudinally with the fastener 110. The flange 220 of the sleeve 320 can be provided with a lip 222 that has a height sufficient to receive the fastener head 112. A tapered upper sleeve recess 224 can be provided which accommodates a tapered portion between the fastener head 112 and the shank 113.

### III. Methods of Use

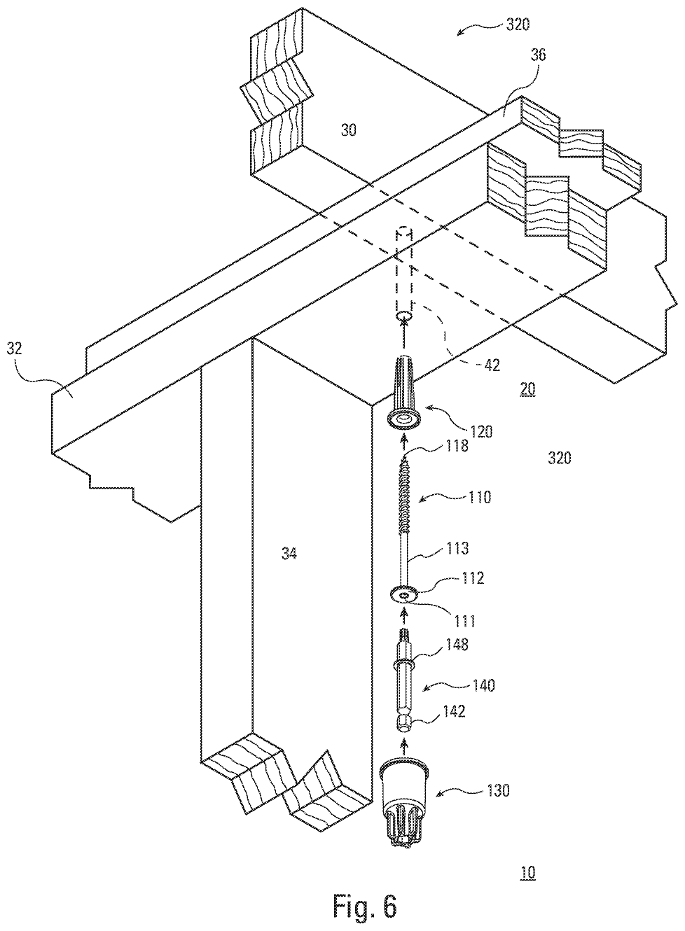

FIG. 6 illustrates use of the fastener installation system 100 to install a fastener 110 and a sleeve 120 to connect a first wood element to a second wood element. An installation guide 130 has a bit 140, which is used to install the sleeve 120 and the fastener 110. The shank end of the bit 140 can be a standard component adapted to be releasably held in the chuck of an electric drill or similar rotary tool. The distal end 20 of the installation guide 130 can be provided with a cylindrical receptacle or cavity 138, which receives the bit 140. The bit can have a distal end 20 that has a hex, Torx, square, X, shape. The cavity 138 is dimensioned to receive the fastener head 112 and the sleeve 120, with the bit 140 engaging a drive socket of the fastener head 112. The depth of the cavity 138 is predetermined to release the fastener head 112 at a desired distance from the surface receiving the installation.

Preliminarily, the user determines whether a flush installation or an offset installation is desired for the particular application. As described above, if needed the user changes the position of the installation guide 130 relative to the secured e-clip 148 to achieve the desired installation result without changing the location of the secured e-clip 148. For the offset drive position, shown in FIG. 1F, the user inserts the distal end 20 of the bit 140 into the proximal end 10 of the channel 134 of the installation guide 130. For the flush drive position, shown in FIG. 1H, the user inserts the proximal end 10 of the bit 140 into distal end 20 of the channel 134 of the installation guide 130 through the cavity 138.

If not already combined, the fastener 110 can be removably positioned within the bore or aperture 250 of the sleeve 120 to form a fastener assembly when combined. The installation guide tool 130 also engages the drive tool directly, or indirectly, via an extension, by inserting the hex shank 142 of the bit 140 into the chuck of the drive tool.

The fastener head 112 fits within an upper sleeve recess 224 of the flange 220 of the sleeve 120. The fastener assembly is loaded into the cavity 138 of installation guide 130. Once the fastener assembly and the installation guide are engaged, the fastener assembly is then inserted into the hole 42, so that the tip of the fastener 110 impinges on the joist 44. As the drive tool is activated, the fastener assembly is inserted into hole 42. Advancing the sleeve 120 of the fastener assembly through hole 42 causes the sleeve to be squeezed around the fastener 110. The longitudinal slits 232 cause the sleeve 120 to clamp tightly on the fastener 110 as the fastener 110 is installed. Additionally, the ribs 240 embed into the surface of, for example, the header 32 that also prevents the sleeve 120 from moving after installation.

The depth of the installation guide 130 cavity 138 determines a spacing between the fastener head 112 from the bottom surface of header 32. Thus the fastener head 112 may impinge fully on the surface of header 32 or be spaced apart from the surface of the header 32 by a pre-determined distance to allow flexure of the building framing without damaging the interior non-bearing walls.

As shown in FIG. 6, a driver bit is assembled for flush installation. A top plate 36, such as a ¾″ board, is shown secured atop the header 32 and perpendicular to a wall stud 34 on one side and a joist 30 on another side. A hole 42 may be drilled upwardly through the header 32 and the top plate 36 at a location where the hole 42 will align with the beam or joist 30, or other structural component. As will be appreciated by those of skill in the art, FIG. 6 illustrates a fastener with a built-up top plate rather than a single top plate. From a proximal position the installation guide 130 receives the bit 140 into its cavity, the e-clip 148 of the bit 140 is then positioned inside the installation guide. The bit 140 engages the head 112 of the fastener 110. The fastener 110 passes through the sleeve 120.

The disclosed fastener installation systems 100 and fastener assemblies may be used in several different ways to secure non-bearing walls and the like to building framing. As shown in FIG. 6, a fastener installation system 100 having a shorter fastener 110 and sleeve 120 may be chosen. The length of sleeve 120 can be greater than the height of header 32 by a predetermined length, such as about ¾″. The hole 42 is then drilled vertically upwardly through header 32, and the fastener 110 and sleeve 120 assembly is installed through the hole 42 with the top of the fastener 110 flush with the bottom surface of header 32. The excess length of the sleeve 120 extends through the hole 42 and protrudes upwardly from header 32. The proximal end 10 of the sleeve 120 abuts the bottom surface of the joist 30, so that any excess length of sleeve 120 establishes a gap between the header 32 and the joist 30. The gap enables the frame to undergo loading and accommodate vertical deflection without transferring load to the non-bearing walls, thereby minimizing damage from load transfer such as stress cracks at the corners of door openings, buckled wall sheathing, doors that stick or will not latch, and the like.

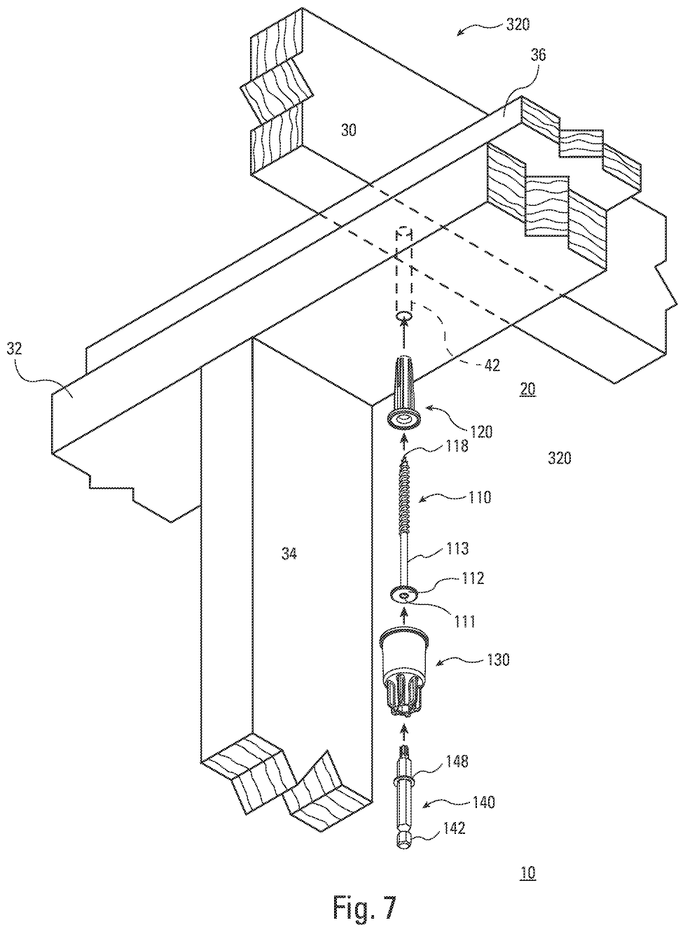

FIG. 7 illustrates use of the system to install a fastener in an offset installation. From a proximal position, the bit 140 passes through the guide member aperture of the installation guide 130, the e-clip 148 of the bit 140 is then positioned on a distal external surface of the installation guide. The bit 140 engages the head 112 of the fastener 110. The fastener 110 passes through the sleeve 120.

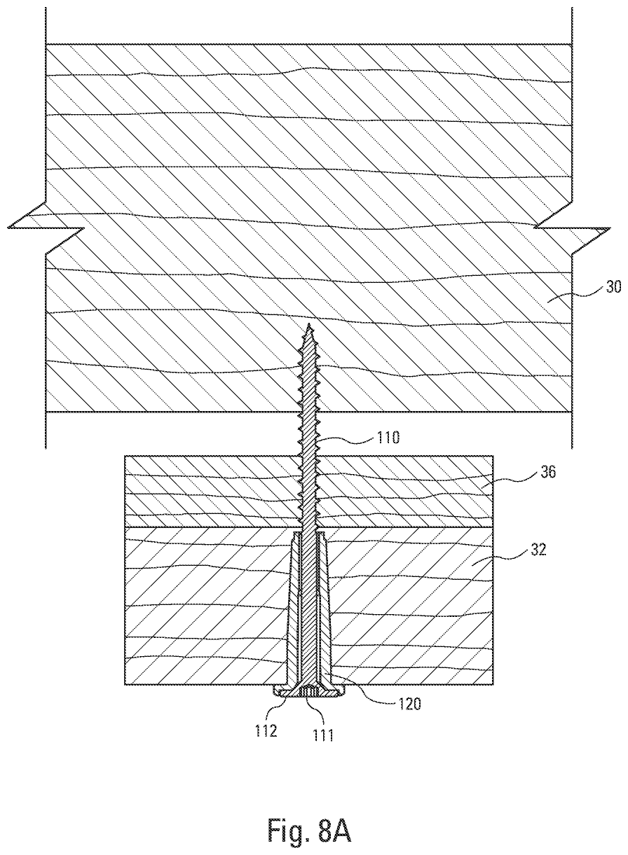

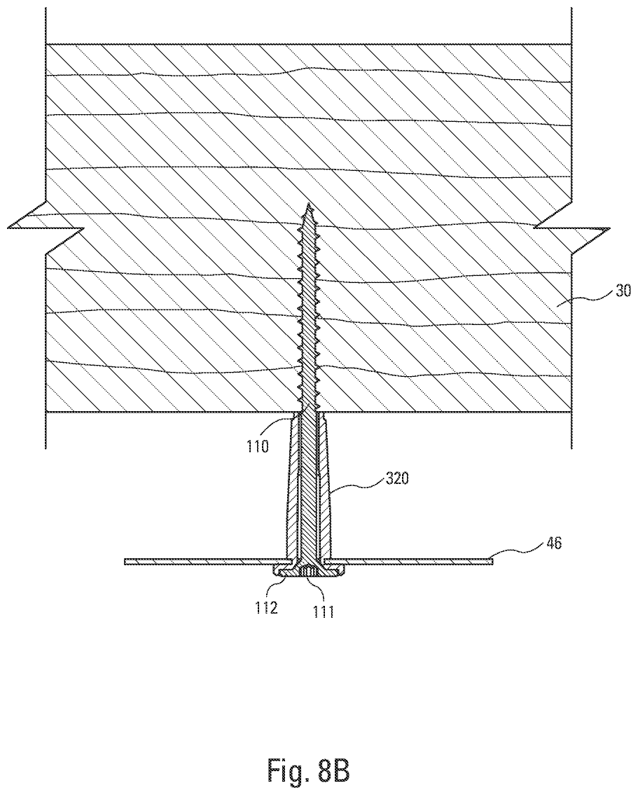

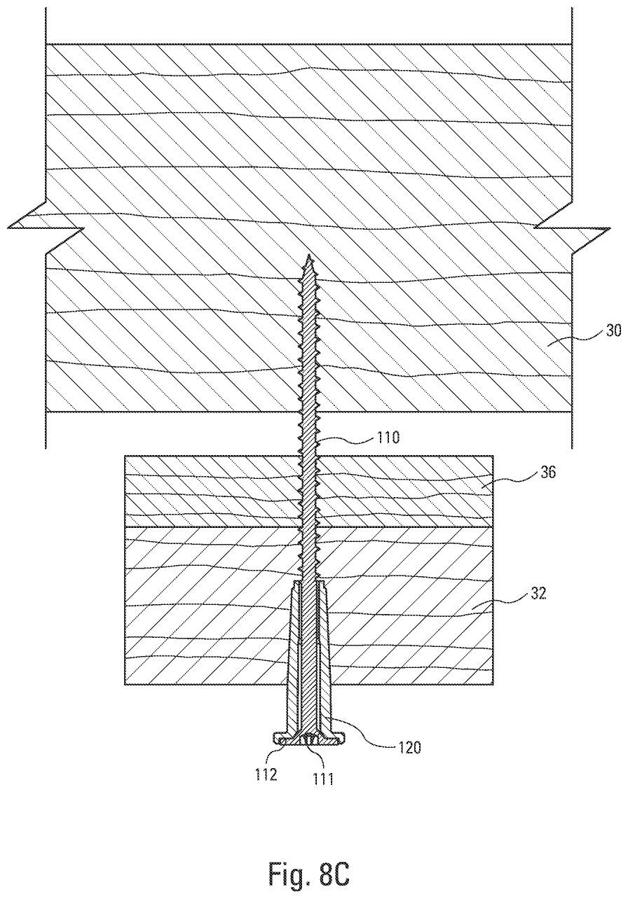

FIG. 8A illustrates an exemplar flush installation of a fastener and a sleeve through a header 32, a top plate 36 and a joist 30.

FIG. 8B illustrates an exemplar installation of a fastener and a sleeve to connect a cold form steel 40 element to a wood element. The cold form steel 40-layer nests in the sleeve body recess 370 during the installation process. Thus, the sleeve body recess 370 prevents the sleeve 110 from moving laterally when the fastener and sleeve assembly are installed through a cold-formed steel 40 layer.

FIG. 8C illustrates an exemplar offset installation of a fastener and a sleeve through a header 32, a top plate 36 and a joist 30. As will be appreciation by those skilled in the art, other installations are possible, including installation with other building materials, without departing from the scope of the disclosure.

As will be appreciated by those skilled in the art, the fastener assemblies disclosed herein are suitable for installing a wall section having a vertical wall stud and a top header extending along the top end of the wall section in a frame structure having a plurality of floor joists or roof trusses. The installation is achieved by providing a plurality of fastener assemblies, each fastener assembly having a threaded fastener extendable through a fastener sleeve having at least one of one or more external ribs and one or more distal slits. Forming a plurality of holes vertically through the top header of the wall section, each hole being generally aligned with one of the floor joists or the roof trusses. Once the holes are formed, extending the sleeve member of one of the fastener assemblies vertically and slidably through one of the holes and through the top header of the wall section. Once the fastener assembly is in position, driving the threaded fastener of the fastener assembly through the sleeve member into the aligned floor joist or roof truss to achieve a spacing gap between the floor joist or roof truss and the top header of the wall section. Once the threaded fastener is anchored in the floor joist or roof truss and the wall section is supported, the spacing gap accommodates vertical deflection of the frame structure without impinging on and loading the wall section. The spacing gap is made during the construction by, for example, making the wall a specified amount shorter than the height to the bottom of the joist/truss.

### IV. Items

The present disclosure relates to the following items:

Item 1: relates to a fastener sleeve comprising a sleeve length from a proximal end to a distal end wherein the fastener sleeve defines a bore for removably receiving a fastener therethrough and further wherein the fastener sleeve has one or more tapered longitudinal ribs on an exterior surface and the one or more tapered longitudinal ribs terminate prior to the distal end of the fastener sleeve.

Item 2: relates to the fastener sleeve of item 1, wherein the fastener sleeve has at least one of a tapered interior diameter and a tapered exterior diameter.

Item 3: relates to the fastener sleeve of item 1, wherein the fastener sleeve has one or more distal slits.

Item 4 relates to the fastener sleeve of item 3, wherein the one or more distal slits has a slit length less than the fastener sleeve length.

Item 5: relates to the fastener sleeve of item 1, wherein the distal end of the fastener sleeve is operable to flex radially outward.

Item 6: relates to the fastener sleeve of item 1, wherein the fastener sleeve has a proximal flange.

Item 7: relates to the fastener sleeve of item 6, wherein the proximal flange of the fastener sleeve has a recess on a proximal surface operable to receive a fastener head.

Item 8: relates to the fastener sleeve of item 6, wherein the fastener sleeve further comprises a proximal sleeve body recess between a proximal end of the one or more ribs and a lower surface of the proximal flange.

Item 9: relates to a fastener sleeve comprising a sleeve length from a proximal end to a distal end wherein the fastener sleeve defines a bore for removably receiving a fastener therethrough and further wherein the fastener sleeve has an integrally formed proximal flange and one or more distal slits.

Item 10: relates to the fastener sleeve of item 9, wherein the fastener sleeve has at least one of a tapered interior diameter and a tapered exterior diameter.

Item 11: relates to the fastener sleeve of item 9, wherein the fastener sleeve further comprises one or more longitudinal ribs having a tapered depth along a length of the one or more longitudinal ribs.

Item 12: relates to the fastener sleeve of item 9, wherein the one or more distal slits has a slit length less than the fastener sleeve length.

Item 13: relates to the fastener sleeve of item 9, wherein the distal end of the fastener sleeve is operable to flex radially outward.

Item 14: relates to the fastener sleeve of item 9, wherein the proximal flange has a recess on a proximal surface operable to receive a fastener head.

Item 15: relates to the fastener sleeve of item 9, wherein the fastener sleeve further comprises a proximal sleeve body recess between a proximal end of the one or more ribs and a lower surface of the proximal flange.

Item 16: relates to a fastener assembly comprising: a fastener; and a fastener sleeve with a sleeve length from a proximal end to a distal end wherein the fastener sleeve defines a bore for removably receiving a fastener therethrough and further wherein the fastener sleeve has one or more tapered longitudinal ribs on an exterior surface and the one or more tapered longitudinal ribs terminate prior to the distal end of the fastener sleeve.

Item 17: relates to the fastener assembly of item 16, wherein the fastener sleeve has at least one of a tapered interior diameter and a tapered exterior diameter.

Item 18: relates to the fastener assembly of item 16, wherein the fastener sleeve has one or more distal slits.

Item 19: relates to the fastener assembly of item 16, wherein the one or more distal slits has a slit length less than the fastener sleeve length.

Item 20: relates to the fastener assembly of item 16, wherein the distal end of the fastener sleeve is operable to flex radially outward.

Item 21: relates to the fastener assembly of item 16, wherein the fastener sleeve has a proximal flange.

Item 22: relates to the fastener assembly of item 21, wherein the proximal flange of the fastener sleeve has a recess on a proximal surface operable to receive a fastener head.

Item 23: relates to the fastener assembly of item 21, wherein the fastener sleeve further comprises a proximal sleeve body recess between a proximal end of the one or more ribs and a lower surface of the proximal flange.

Item 24: relates to a fastener assembly comprising: a fastener; and a fastener sleeve with a sleeve length from a proximal end to a distal end wherein the fastener sleeve defines a bore for removably receiving a fastener therethrough and further wherein the fastener sleeve has an integrally formed proximal flange and one or more distal slits.

Item 25: relates to the fastener assembly of item 24, wherein the fastener sleeve has at least one of a tapered interior diameter and a tapered exterior diameter.

Item 26: relates to the fastener assembly of item 24, wherein the fastener sleeve further comprises one or more longitudinal ribs having a tapered depth along a length of the one or more longitudinal ribs.

Item 27: relates to the fastener assembly of item 24, wherein the one or more distal slits has a slit length less than the fastener sleeve length.

Item 28: relates to the fastener assembly of item 24, wherein the distal end of the fastener sleeve is operable to flex radially outward.

Item 29: relates to the fastener assembly of item 24, wherein the proximal flange has a recess on a proximal surface operable to receive a fastener head.

Item 30: relates to the fastener assembly of item 24, wherein the fastener sleeve further comprises a proximal sleeve body recess between a proximal end of the one or more ribs and a lower surface of the proximal flange.

Item 31: relates to an installation method including the steps of: providing a fastener assembly comprising a fastener having a fastener head and a threaded shaft, and a removable fastener sleeve; extending the fastener sleeve member of the fastener assembly through a hole in a target surface; and driving the threaded shaft of the fastener into the target surface while also setting a spacing gap, whereby the threaded fastener is anchored in the target surface, and the spacing gap accommodates a deflection of the target surface.

Item 32: relates to the installation method of item 31, wherein a flange at a proximal end of the fastener sleeve is larger in diameter than the hole in the target surface.

Item 33: relates to the installation method of item 31, further including the step of providing an installation guide with a bit for engaging and rotating the fastener head, wherein the installation guide has an axially aligned receptacle dimensioned to releasably retain the fastener assembly to provide a known depth to achieve at least one of a flush installation of the fastener assembly and an offset installation of the fastener assembly.

Item 34: relates to the installation method of item 31, wherein the fastener assembly is installed through a hole from below, and the fastener is threaded into a floor joist or a roof truss.

Item 35: relates to the installation method of item 31, wherein the fastener has a length greater than a length of the fastener sleeve.

Item 36: relates to the installation method of item 31, wherein the fastener can translate within the fastener sleeve member to accommodate a vertical deflection.

Item 37: relates to the installation method of item 31, wherein the fastener sleeve can translate within a hole to accommodate deflection without loading a wall section.

Item 38: relates to the installation method of item 31, further including the step of providing a mounting clip for a ceiling panel installed adjacent to a wall section, wherein the mounting clip is secured to an edge portion of the ceiling panel and spaced about a perimeter of the ceiling panel.

Item 39: relates to the installation method of item 38, further including the step of securing the mounting clip to a top header of the wall section wherein the mounting clip is being free of attachment to a floor joists or a roof truss.

Item 40: relates to the installation method of item 31, further including the step of forming a hole through a target surface.

Item 41: relates to system comprising: a fastener; a fastener sleeve having a sleeve length from a proximal end to a distal end wherein the fastener sleeve defines a bore for removably receiving the fastener therethrough and further wherein the fastener sleeve has one or more longitudinal ribs on an exterior surface; a bit having an e-clip; and an installation guide operable to securely receive a bit through a central aperture wherein the installation guide has a first configuration for an offset installation and a second configuration for a flush installation.

Item 42: relates to the system of item 41, wherein the fastener sleeve has at least one of a tapered interior diameter and a tapered exterior diameter.

Item 43: relates to the system of item 41, wherein the fastener sleeve the one or more longitudinal ribs have a tapered depth along a length of the one or more longitudinal ribs.

Item 44: relates to the system of item 41, wherein the one or more longitudinal ribs terminate prior to the distal end of the fastener sleeve.

Item 45: relates to the system of item 41, wherein the fastener sleeve has one or more distal slits.

Item 46: relates to the system of item 45, wherein the one or more distal slits has a slit length less than the fastener sleeve length.

Item 47: relates to the system of item 41, wherein the distal end of the fastener sleeve is operable to flex radially outward.

Item 48: relates to the system of item 41, wherein the fastener sleeve has a proximal flange.

Item 49: relates to the system of item 48, wherein the proximal flange has a recess on a proximal surface operable to receive a fastener head.

Item 50: relates to the system of item 48, wherein the fastener sleeve further comprises a proximal sleeve body recess between a proximal end of the one or more ribs and a lower surface of the proximal flange.

Item 51: relates to the system of item 41, wherein the installation guide has a plurality of external ribs and a distal cavity.

Item 52: relates to a kit comprising: a fastener; a fastener sleeve having a sleeve length from a proximal end to a distal end wherein the fastener sleeve defines a bore for removably receiving the fastener therethrough further wherein the fastener sleeve has one or more tapered longitudinal ribs on an exterior surface and the one or more tapered longitudinal ribs terminate prior to the distal end of the sleeve; a bit having an e-clip; and an installation guide operable to securely receive a bit through a central aperture wherein the installation guide has a first configuration for an offset installation and a second configuration for a flush installation.

Item 53: relates to a kit comprising: a fastener; a fastener sleeve with a sleeve length from a proximal end to a distal end wherein the fastener sleeve defines a bore for removably receiving a fastener therethrough and further wherein the fastener sleeve has an integrally formed proximal flange and one or more distal slits; a bit having an e-clip; and an installation guide operable to securely receive a bit through a central aperture wherein the installation guide has a first configuration for an offset installation and a second configuration for a flush installation.

Item 54: relates to a method for installing a wall section having vertical wall studs and a top header extending along like top ends of the wall section, in a frame structure having a plurality of floor joists or roof trusses extending above the wall section, including the steps of: providing a plurality of fastener assemblies, each fastener assembly having a threaded fastener extending through a sleeve member, each sleeve member have at least one of one or more external ribs, and one or more distal slits; forming a plurality of holes extending vertically through the top header of the wall section, each hole being generally aligned with one of the floor joists or roof trusses; and extending the sleeve member of one of the fastener assemblies vertically and slidably through one of the holes and through the top header of the wall section and driving the respective threaded fastener through the sleeve member into the aligned floor joist or roof truss while also setting a spacing gap between the floor joist or roof truss and the top header of the wall section, whereby the threaded fasteners are anchored in the floor joists or roof trusses and the wall section is supported, and the spacing gap accommodates vertical deflection of the frame structure without impinging on and loading the wall section.

Item 55: relates to the method for installing a wall section of item 54, further including providing a sleeve head at one end of each of the sleeve members, the sleeve head being larger in diameter than the hole in the top header of the wall section; further including providing a fastener rotary driver bit for engaging and rotating the threaded fastener head and the sleeve head, the fastener rotary driver bit having an axially aligned receptacle dimensioned to releasably retain the threaded fastener head and the sleeve head; providing the receptacle of the fastener rotary driver bit with a known depth that sets a predetermined spacing between the sleeve head and a surface into which the fastener assembly is driven, the predetermined spacing forming the spacing gap.

Item 56: relates to the method for installing a wall section of item 55, further including providing the sleeve head with a counter bore sized to receive the threaded fastener head therein.

Item 57: relates to the method for installing a wall section of item 56, wherein the fastener assemblies are installed through the holes from below, and the threaded fasteners are threaded into the floor joists or roof trusses from below.

Item 58: relates to the method for installing a wall section of item 54, wherein the threaded fastener is greater in length than the sleeve.

Item 59: relates to the method for installing a wall section of item 54, wherein the threaded fastener is capable of translation within the sleeve member to accommodate vertical deflection of the frame structure without impingement on and loading of the wall section.

Item 60: relates to the method for installing a wall section of item 54, wherein the sleeve member is capable of translation within the respective hole to accommodate vertical deflection of the frame structure without impinging on and loading the wall section.

Item 61: relates to the method for installing a wall section of item 54, further including providing a plurality of mounting clips for a ceiling panel installed adjacent to the wall section, the mounting clips being secured to edge portions of the ceiling panel and spaced about the perimeter of the ceiling panel.

Item 62: relates to the method for installing a wall section of item 61, further including the step of securing the mounting clips to the top header of the wall section, the mounting clips being free of attachment to the floor joists or roof trusses supporting the wall section.

Item 63: relates to an apparatus for installing a wall section having vertical wall studs and a top header extending along like top ends of the wall section, in a frame structure having a plurality of floor joists or roof trusses extending above the wall section, including: a plurality of fastener assemblies, each having a threaded fastener extending through a sleeve member; a plurality of holes extending vertically in the top header of the wall section, each hole being generally aligned with one of the floor joists or roof trusses; one of the sleeve members extending vertically and slidably through one of the holes and through the top header of the wall section with the respective threaded fastener extending through the sleeve member and driven into the aligned floor joist or roof truss; and a fastener rotary driver bit for engaging and rotating the threaded fasteners and including means to establish a spacing gap between the floor joist or roof truss and the top header of the wall section, whereby the threaded fasteners are anchored in the floor joists or roof trusses and the wall section is supported, and the spacing gap accommodates vertical deflection of the frame structure without impinging on and loading the wall section.

Item 64: relates to the apparatus for installing a wall section of item 63, further including a sleeve head at one end of each of the sleeve members, the sleeve head being larger in diameter than the hole in the top header of the wall section.

Item 65: relates to the apparatus for installing a wall section of item 65, wherein the threaded fastener includes an enlarged head end, and the sleeve head includes a counter bore for receiving the enlarged head end in complementary fashion.

Item 66: relates to the apparatus for installing a wall section of item 65, the fastener rotary driver bit having an axially aligned receptacle dimensioned to releasably retain the threaded fastener head and the sleeve head.

Item 67: relates to the apparatus for installing a wall section of item 66, wherein the receptacle of the fastener rotary driver bit includes a known depth that sets a predetermined spacing between the sleeve head and a surface into which the fastener assembly is driven, the predetermined spacing forming the spacing gap.

Item 68: relates to the apparatus for installing a wall section of item 63, wherein the threaded fastener is greater in length than the sleeve.

Item 69: relates to the apparatus for installing a wall section of item 63, wherein the threaded fastener is capable of translation within the sleeve member to accommodate vertical deflection of the frame structure without impingement on and loading of the wall section.

Item 70: relates to the apparatus for installing a wall section of item 63, wherein the sleeve member is capable of translation within the respective hole to accommodate vertical deflection of the frame structure without impinging on and loading the wall section.

Item 71: A method for installing a wall section having vertical wall studs and a top header extending along like top ends of the wall section, in a frame structure having a plurality of floor joists or roof trusses extending above the wall section, including the steps of: providing a plurality of fastener assemblies, each one of the plurality of fastener assemblies having a threaded fastener extending through a sleeve member having at least one of one or more ribs on an exterior surface and one or more distal slits, wherein each one of the threaded fasteners has a fastener head and a fastener length that is greater than a length of the sleeve member; forming a plurality of holes extending vertically through the top header of the wall section, each of the plurality of holes being generally aligned with one of the floor joists or roof trusses wherein each one of the plurality of holes is configured to receive one of the plurality of fastener assemblies; and extending each one of the plurality of fastener assemblies vertically and slidably through one of the plurality of holes and driving each one of the threaded fasteners through its corresponding sleeve member into the aligned floor joist or roof truss while also setting a spacing gap between the floor joist or roof truss and the top header of the wall section for each one of the fastener assemblies, whereby each one of the threaded fasteners are anchored in the floor joists or roof trusses and the wall section is supported, and each one of the spacing gaps between the floor joist or roof truss for each of the fastener assemblies accommodates vertical deflection of the frame structure without impinging on and loading the wall section.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

1. A fastener sleeve comprising a sleeve length from a proximal end to a distal end wherein the fastener sleeve defines a bore for removably receiving a fastener therethrough and further wherein the fastener sleeve has one or more longitudinal ribs on an exterior surface and the one or more longitudinal ribs terminate prior to the distal end of the fastener sleeve.

2. The fastener sleeve of claim 1, wherein the fastener sleeve has at least one of a tapered interior diameter and a tapered exterior diameter.

3. The fastener sleeve of claim 1, wherein the fastener sleeve has one or more distal slits.

4. The fastener sleeve of claim 3, wherein the one or more distal slits has a slit length less than the fastener sleeve length.

5. The fastener sleeve of claim 1, wherein the distal end of the fastener sleeve is operable to flex radially outward.

6. The fastener sleeve of claim 1, wherein the fastener sleeve has a proximal flange.

7. The fastener sleeve of claim 6, wherein the proximal flange of the fastener sleeve has a recess on a proximal surface operable to receive a fastener head.

8. The fastener sleeve of claim 6, wherein the fastener sleeve further comprises a proximal sleeve body recess between a proximal end of the one or more ribs and a lower surface of the proximal flange.

9. A fastener sleeve comprising a sleeve length from a proximal end to a distal end wherein the fastener sleeve defines a bore for removably receiving a fastener therethrough and further wherein the fastener sleeve has a proximal flange and one or more distal slits.

10.-15. (canceled)

16. A fastener assembly comprising:
a fastener; and
a fastener sleeve with a sleeve length from a proximal end to a distal end wherein the fastener sleeve defines a bore for removably receiving a fastener therethrough and further wherein the fastener sleeve has one or more longitudinal ribs on an exterior surface and the one or more longitudinal ribs terminate prior to the distal end of the fastener sleeve.

17. The fastener assembly of claim 16, wherein the fastener sleeve has at least one of a tapered interior diameter and a tapered exterior diameter.

18. The fastener assembly of claim 16, wherein the fastener sleeve has one or more distal slits.

19. The fastener assembly of claim 18, wherein the one or more distal slits has a slit length less than the fastener sleeve length.

20. The fastener assembly of claim 16, wherein the distal end of the fastener sleeve is operable to flex radially outward.

21. The fastener assembly of claim 16, wherein the fastener sleeve has a proximal flange.

22. The fastener assembly of claim 21, wherein the proximal flange of the fastener sleeve has a recess on a proximal surface operable to receive a fastener head.

23. The fastener assembly of claim 21, wherein the fastener sleeve further comprises a proximal sleeve body recess between a proximal end of the one or more ribs and a lower surface of the proximal flange.

24. A fastener assembly comprising:
a fastener; and
a fastener sleeve with a sleeve length from a proximal end to a distal end wherein the fastener sleeve defines a bore for removably receiving a fastener therethrough and further wherein the fastener sleeve has a proximal flange and one or more distal slits.

25.-50. (canceled)

52. A kit comprising:
a fastener;
a fastener sleeve having a sleeve length from a proximal end to a distal end wherein the fastener sleeve defines a bore for removably receiving the fastener therethrough further wherein the fastener sleeve has one or more tapered longitudinal ribs on an exterior surface and the one or more tapered longitudinal ribs terminate prior to the distal end of the sleeve;
a bit having an e-clip; and
an installation guide operable to securely receive a bit through a central aperture wherein the installation guide has a first configuration for an offset installation and a second configuration for a flush installation.

53. A kit comprising:
a fastener;
a fastener sleeve with a sleeve length from a proximal end to a distal end wherein the fastener sleeve defines a bore for removably receiving a fastener therethrough and further wherein the fastener sleeve has a proximal flange and one or more distal slits;
a bit having an e-clip; and
an installation guide operable to securely receive a bit through a central aperture wherein the installation guide has a first configuration for an offset installation and a second configuration for a flush installation.
